(19) United States
(12) Patent Application Publication
(10) Pub. No.: US 2019/0380495 A1
(43) Pub. Date: Dec. 19, 2019

(54) WALL OF A FURNITURE ELEMENT AND FURNITURE ELEMENT OR ITEM OF FURNITURE HAVING SAID TYPE OF WALL

(71) Applicant: AMBIGENCE GMBH & CO. KG, Herford (DE)

(72) Inventors: Uwe SOBOLEWSKI, Bünde (DE); Norbert POPPENBORG, Bad Salzuflen (DE); Stefan ANDSCHUS, Lübbecke (DE); Michael TASCHE, Bielefeld (DE); Gerhard GÖTZ, Bünde (DE)

(21) Appl. No.: 16/489,176

(22) PCT Filed: Feb. 23, 2018
(86) PCT No.: PCT/EP2018/054530

§ 371 Date: Aug. 27, 2019

(30) Foreign Application Priority Data
Feb. 28, 2017 (DE) 10 2017 104 184.2

(51) Int. Cl. A47B 96/20; E05D 3/06

(52) U.S. Cl. CPC A47B 96/205; E05Y 2900/20; E05D 3/06

(57) ABSTRACT

A wall of a furniture element includes a fitting for guiding a moveable furniture part, the fitting is integrated into the wall and that the wall includes on at least one side an additional fitting for guiding the structure element.

### BACKGROUND AND SUMMARY OF THE INVENTION

Exemplary embodiments of the invention relate to a wall of a furniture body having a fitting for guiding a movable part of the furniture. Exemplary embodiments of the invention also relate to a furniture body or a piece of furniture having such a wall.

Furniture, in particular kitchen furniture such as base units, wall units or wall cabinets, generally have a furniture body open towards the front, on which movable furniture parts guided by fittings are mounted. The movably guided furniture parts can be drawers with a drawer front or doors or flaps, which can be used individually or in different combinations in a furniture body. The present application relates in particular to the use of doors and flaps as movable furniture components. For the purposes of this application, doors and flaps are distinguished by the orientation of their pivot axis, which extends vertically for doors and horizontally for flaps.

The doors and flaps can be integral or consist of several individual parts, such as a folding flap in which different parts of the flap move relative to each other in the movement sequence.

Door hinges are usually used to guide doors, which are arranged on the side of the pivot axis between the furniture body and the door. A comparable arrangement of hinges can also principally be used for flaps. These hinges are then arranged along an upper side edge of the flap. However, it is often desired to open the flaps in a combined pivoting and sliding movement in order, for example in the case of a wall cabinet, to obtain the greatest possible access to the interior of the cabinet without having to pivot the flap into a horizontal position in which it is difficult or impossible for the user to reach it to close. For this reason, special flap fittings have become established that are not arranged along the pivot axis between the furniture body and the flap, but laterally on the side edges (usually both) between the flap and the side wall of the furniture body.

Such door hinges or flap fittings are well known for mounting on the inside of the side wall or side walls of the furniture body. However, the fittings inevitably protrude into the interior of the furniture body, which on the one hand reduces the usable storage space within the furniture body and on the other hand also impairs the subdivision or structuring of the interior of the furniture body.

For the effective and clear use of the interior of a furniture body, cabinet dividers or comparable structuring elements are usually provided to divide the interior into smaller compartments or units in order to have more space available and to structure the interior. In the simplest case, such a cabinet divider is a horizontal or vertical partition wall. A horizontal partition wall is often referred to as an intermediate shelf.

In order to provide a high degree of flexibility, the cabinet dividers are preferably easy to assemble in different positions. This can be done without tools so that the user can insert the cabinet dividers into the cabinet as required and in variable positions. For this purpose, for example, it is known that two rows of holes with equally spaced holes are provided in each side wall of the furniture body. Plugs at the desired height are inserted into these, on which an intermediate shelf can be positioned.

In practice, however, the flexibility of positioning an intermediate shelf, for example, is limited because the fittings with which the doors or flaps of the furniture are guided are usually mounted on the side wall. For example, an intermediate shelf can only be arranged above or below such a fitting, or a cutout or notch must be made manually and in individual cases in the corresponding intermediate shelf in order to keep free the space occupied by the fitting statically or during the opening movement. Especially for cabinets mounted above or below eye level, the above-mentioned structuring elements provide a larger storage space, but this is not necessarily easily accessible.

It is known for the assembly of door hinges to mill a pocket into the end face of a side wall in which the door hinge can be inserted from the front. In this way, the inside of the side wall remains free. A hinge suitable for use in such a milled pocket is known from the publication DE 1559963, for example.

However, this procedure is only suitable for door hinges with a very low installation depth. This is due to the limited milling depth with which such a pocket can be economically milled from the end face into the side wall during the manufacturing process. The installation thickness of the door hinge inserted in such a milled pocket is also very limited, as the side walls in the furniture area only have a wall thickness of about 16-20 mm (millimeters). During the milling process, a certain minimum wall thickness must remain on the side of the milled pockets, since a wall that is too thin would tear or break during the milling process or would be deformed in such a way that it no longer has a perfect surface.

Even the use of larger and more complex door hinges is not possible in this way. Flap hinges usually have a large installation depth of more than 10 or 15 cm (centimeters), which cannot be achieved by milling from the end face.

Publication DE 20 2013 003 189 U1 discloses a side wall for a furniture body that is made of different parts in sections. In particular, a rear part facing away from the furniture front is conventionally designed, e.g., by a coated wooden element. A front part of the side wall is formed by a housing, not described in detail in the above publication, which has at least one front opening into which a fitting can be inserted. The housing is connected to the conventional part of the side wall, e.g., via dowels or screws. Since the housing can be provided with thinner housing walls than is possible by milling and also allows larger installation depths, this housing can also be used to accommodate larger door hinges or a flap fitting. However, the surface appearance and haptics of the housing will generally not correspond exactly to those of the conventional part of the side wall, so that a uniform surface of the side wall cannot be achieved. In addition, the design possibilities of the interior space are also severely restricted here, as it is not possible, or only possible at great expense, to attach cabinet dividers or other structuring elements for the interior space to the housing of the fitting.

Exemplary embodiments of the present invention are directed to a wall of a furniture body in which also larger fittings, in particular flap fittings or door hinges with a larger installation depth, can be used and in which great flexibility in the use of structuring elements for the interior of the furniture body and in which an additional storage space created by the structuring elements is easily accessible. Exemplary embodiments also relate to a piece of furniture or a furniture body having such a wall.

A wall of the type mentioned at the beginning and according to the invention is characterized in that the fitting is integrated into the wall and that the wall has a further fitting on at least one side for guiding the structuring element.

Since the fitting is integrated into the wall of the furniture body, the entire side of the wall is available as a surface to which the additional fitting can be attached. Movements of the structuring element are not hindered by parts of the fitting for the movable part of the furniture, in particular the door or flap. For example, a pivot fitting can be used as a further fitting on which an intermediate shelf from the interior of the furniture body is pivoted about a horizontal axis. The intermediate shelf moves along the inner cover layer of the (side) wall of the furniture body, which would not be possible if this surface were occupied by the door or flap fitting.

The invention proves to be particularly advantageous if the vertical projection surfaces of the contours of the fitting integrated into the wall and of the further fitting as well as of the areas covered by the respective motion sequences at least partially overlap each other.

In an advantageous embodiment of the wall, the at least one core is arranged in one plane with the fitting. Fitting and core are preferably arranged between two continuous cover layers and are preferably connected to the core and/or at least one of the cover layers, in particular laminated thereon. This provides the fitting with an installation width that corresponds to the maximum thickness of the core. Fittings with a width of up to approx. 20 mm can also be used for furniture walls of the usual thickness.

In another advantageous embodiment of the wall, the at least one further fitting is attached to one or both cover layers. This means that the additional fitting can also be arranged in the area of the wall in which the integrated fitting is positioned. Alternatively, fastening means for the other fitting can also reach into the integrated fitting at a suitable point.

In another advantageous embodiment of the wall, the at least one further fitting is a pivot fitting in order to guide the movable structuring element in a plane parallel to the cover layers. Such a fitting comprises, for example, a lever mechanism with lever arms, which are pivotably mounted on pivot bearings at the wall. For example, an intermediate shelf can be pivoted out of a furniture body.

Alternatively, or additionally, the at least one further fitting can be a guide fitting in order to move the movable structuring element linearly. In this way, for example, an intermediate shelf can be arranged so that it can be moved out of a furniture body.

In another advantageous embodiment of the wall, the at least one further fitting is fastened with fastening means in bores in the cover layer. It is also possible that at least one such bore penetrates into an area provided on the fitting in order to receive a fastening means for the further fitting. For this purpose, the fitting may have sleeve-like recesses positioned behind the bore through the cover layer. Preferably, those areas of the fitting that accommodate fastening means are made of solid material that differs from the basic material of the fitting. The basic material of the fitting is usually a metal, while the solid material is preferably a plastic or wood material.

In another advantageous embodiment of the wall, the integrated fitting comprises a lever mechanism that guides the movable furniture part. When the movable part of the furniture is closed, the lever mechanism is preferably located between the cover layers. The fitting is then so completely integrated into the furniture body that—unavoidably—only the lever mechanism is visible, and even this only when the movable part of the furniture is open.

In a preferred embodiment, the lever mechanism is arranged in a front area of the fitting. An energy accumulator for applying force to the lever mechanism is arranged in a rear area of the fitting. The energy accumulator serves, for example, to compensate the force of the weight of a guided furniture part, e.g., a flap. An area for the hole for the fastening means for the further fitting can then preferably be located between the lever mechanism and the energy accumulator in the integrated fitting.

In another advantageous embodiment of the wall, at least one edge band is applied to at least one end face of the core. In the area of the front end face of the core, the edge band is preferably applied only when the fitting has been integrated or inserted, wherein the edge band is arranged at least in sections on the fitting. In this way, for example, the edges of the side plates of the fitting can be covered.

A piece of furniture according to the invention or a furniture body according to the invention is characterized by the use of at least one such wall, for example as a side wall, partition wall and/or top panel, bottom panel or intermediate shelf. This results in the advantages explained in connection with the wall.

In advantageous embodiments of the piece of furniture or furniture body, the wall has a door or flap fitting as a fitting. Preferably at least one structuring element for the interior is present which is guided over at least one other fitting.

Within the framework of the application, the wall can represent any flat structural element of the furniture body, regardless of its orientation. In particular, the wall can be a (vertical) side wall or partition wall or a (horizontal) top panel, bottom panel or intermediate shelf. An inclined, for example diagonal arrangement is also possible.

### BRIEF DESCRIPTION OF THE DRAWING FIGURES

The invention will be explained in more detail in the following by means of embodiment examples shown in the figures, wherein:

FIGS. 1a, b each show an isometric representation of a piece of furniture having a side wall in accordance with the application and according to an embodiment example;

FIG. 2 shows an isometric exploded view of the side wall according to FIG. 1; and

FIG. 3 shows a schematic top view of a front end face of a composite element in the area of an inserted fitting.

### DETAILED DESCRIPTION

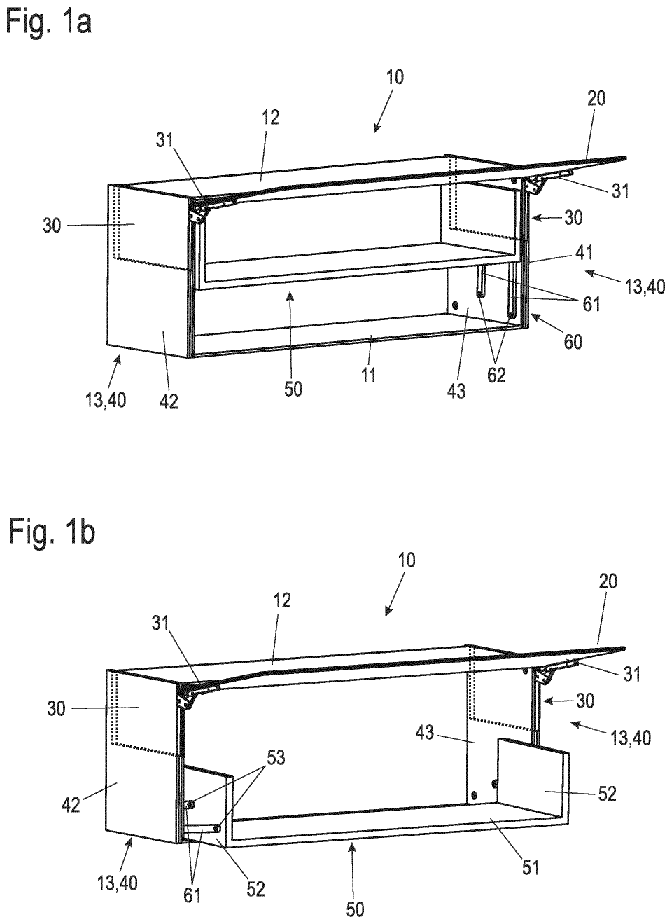

FIG. 1 shows in the upper left part of the image an isometric representation of a wall unit, for example a kitchen, as the first embodiment example of a piece of furniture with a (side) wall in accordance with the application.

The wall unit comprises a furniture body 10 with bottom panel 11 and top panel 12 as well as two side walls 13. A rear wall is preferred for reasons of stability but is not shown in this embodiment example.

The furniture body 10 is open to the front to allow access to the interior of the cupboard. An integral flap 20 is provided to close the opening of the furniture body 10. The integral flap 20 can be pivoted along its upper horizontal side edge. For this purpose, fittings 30 are provided which are connected to the integral flap 20 with a lever mechanism 31 in the upper part of the flap 20.

The fittings 30 (with the exception of the lever mechanism 31 extended in the opening position shown) are arranged within the respective side wall 13. When flap 20 is closed, the lever mechanism 31 may be fully retracted into the side wall 13, except for the mounting elements for connecting it to flap 20.

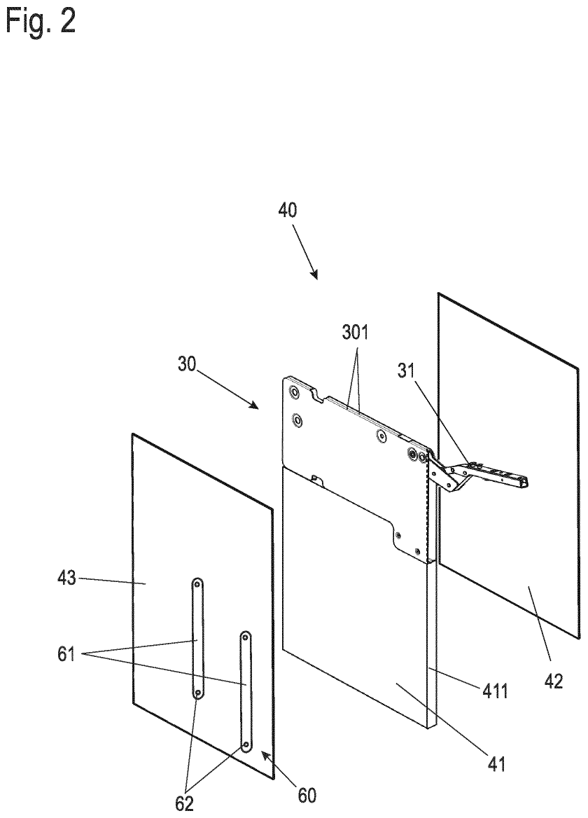

The side walls 13 of furniture body 10 are designed as composite elements 40 in which fitting 30 is integrated. An exemplary structure of such a composite element 40 is explained in more detail below in connection with FIG. 2.

A pivotable intermediate shelf 50 is arranged in the wall unit as a structuring element for the interior of the furniture body 10. The pivotable intermediate shelf 50 is shown in FIG. 1a in a pivoted position and in FIG. 1b in a position pivoted downwardly and forwardly.

The pivotable intermediate shelf 50 comprises a shelf 51 and two side panels 52. In addition, a rear wall or rear wall segment can be provided at the same height as the side panels 52 or at a lower or higher height that deviates therefrom.

The pivotable intermediate shelf 50 is fastened on both sides to the corresponding side wall 13 and thus to the composite element 40 via a further fitting 60 on each side.

The further fittings 60 each have a lever mechanism 61, which consists of two levers that allow the intermediate shelf 50 to pivot while maintaining the horizontal orientation of the shelf 51. The lever mechanism 61 is fixed to the intermediate shelf 50 via pivot bearing 53 and to the respective composite element 40 via pivot bearing 62.

In the retracted position of the intermediate shelf 50 shown in FIG. 1a, it is arranged like a fixed intermediate shelf at approximately half height in the interior of the furniture body 10.

In order to have easy access to the stowage material stored in the wall unit, even when the wall unit is hanging high, the intermediate shelf 50 can be pivoted downwards and outwards, as shown in FIG. 1b. Due to the pivoting movement through the two further fittings 60, the pivotable intermediate shelf 50 moves over the stowage material arranged in the lower part of the furniture body 10. A damping unit may be provided to damp the lowering of the intermediate shelf 50. The damping unit may comprise one or more linear or rotary dampers, for example one for each further fitting 60.

The pivotable intermediate shelf 50 fills the essentially entire width of the interior of the furniture body 10. Only a narrow gap remains between the side parts 52 and the respective adjacent side wall 13 to accommodate the lever mechanism 61 of the further fitting 60, including a free space, so that the lever mechanism 61 does not drag along the cover layer 43 or the side part 52 during movement.

The fact that the fittings 30, which carry the flap 20, are arranged within the composite elements 40 makes a pivoting movement, such as the pivotable intermediate shelf 50 and in particular the side parts 52, possible in the first place. In addition, the continuous cover layer 43 offers fastening options for the further fitting 60, i.e., in this case the pivot bearing 62, in any position on the entire surface. The further fitting 60, for example, could also be fixed in the area of fitting 30, if this is necessary.

The design of the further fitting 60 as pivot fitting in the example of FIGS. 1a and 1b is purely exemplary. It is also possible to make intermediate shelves horizontally extendable using guide rails. One or more of these additional fittings 60 can be mounted on each of the side walls 13 or on each composite element 40.

If the composite element 40 does not form the side wall 13, as in the example shown, but a partition wall arranged inside the interior of the furniture body 10, a further fitting 60 may be arranged on either side of the composite element 40.

FIG. 2 shows in an isometric exploded view of a possible structure of such a composite element 40 and also illustrates its manufacture.

The composite element 40 has a core 41, for example made of a chipboard or a medium or high density fiberboard (MDF Medium Density Fiberboard or HDF High Density Fiberboard) or a lightweight panel. The fitting 30 is arranged in the same plane as the core 41 and preferably with the same thickness, in such a way that the shape and size of the core 41 and the fitting 30 complement each other in such a way that together they essentially have the dimensions of the composite element 40 and the side wall 13 respectively in the furniture body 10 as shown in FIG. 1. In the example shown, the core 41 is integral and only adjoins below the fitting 30. Alternatively, an additional core element may also be arranged on other sides of fitting 30, in particular on its upper side.

The core 41 and the fitting 30 can be connected to each other via connecting elements, such as screws, clamps, pins, staples or the like, which are not shown here. An adhesive connection can also be provided in addition to the fastening means mentioned or as the only connection.

Cover layers 42, 43 are applied from each side to the arrangement of the core 41 and any fittings 30 connected to it, in particular glued or laminated thereon. With regard to its material and material thickness, the fitting 30 has been chosen, for example, for side plates 301 of fitting 30 in such a way that it is not pressed in even during a laminating process, which could lead to an unevenness of the surface of the cover layers 42, 43. Smaller irregularities in the side plates of fitting 30 are compensated by the cover layers 42, 43. Such smaller unevennesses can, for example, be caused by the bearing positions of bolts which serve the pivotable bearing of the lever mechanism 31 in fitting 30.

The manufacturing process of the composite element 40 symbolized in FIG. 2, in which the core 41 and the fitting 30 are first aligned with each other and, if necessary, connected to each other, and then brought together with the cover layers 42, 43 to form the composite element 40, enables the use of a fitting 30 which extends over the entire width of the composite element 40, for example, as shown. In this way, larger and more complex fittings can also be used in the composite element 40 than would be possible in a pocket milled out at the front of a side wall.

The fitting 30 is fully integrated into the composite element 40. Its lever mechanism 31 projects from the composite element 40 at a front end face 411 of the core 41 when the movable furniture part (e.g., the flap 20 according to FIG. 1a, b) is opened. When the movable furniture part is closed, the fitting 30 is completely inside the composite element 40—with the possible exception of the mounting elements of the lever mechanism 31.

For the further fitting 60, the lever mechanism 61 is shown in FIG. 2 as an example in an outwardly pivoted position.

Alternatively, the core 41 can be divided in the plane of the lateral extension of the composite element 40, so that two core halves with e.g., half material thickness each (compared to the core 41 shown in FIG. 2) are present. A recess is introduced into each of the core halves in which the fitting 30 is inserted. The core halves enclose the fitting 30 like a shell and are connected to each other.

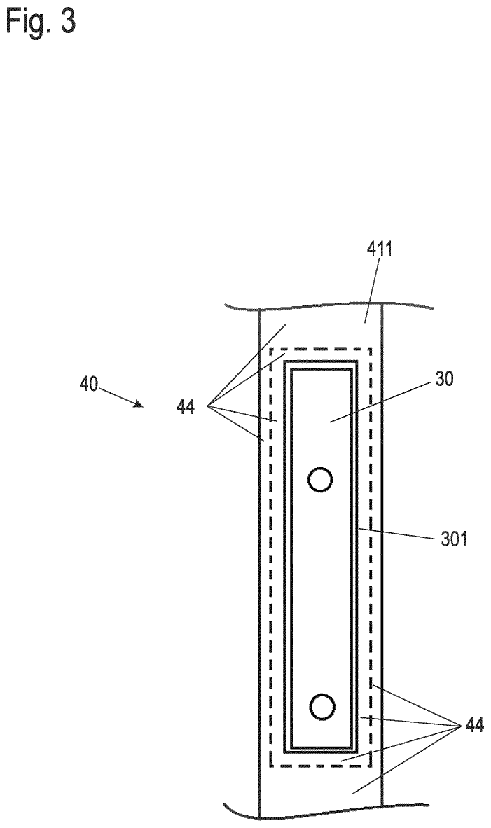

FIG. 3 shows a top view of the front face 411 of a section of a composite element 40 in the area of fitting 30. In this embodiment example, an edge band 44 is applied as a narrow-side coating to the front end face 411 of core 41 and thus of the composite element 40. Further edge bands, which are not visible here, can be applied in the area of further end faces.

In the area of the opening of the fitting 30, from which, for example, the lever mechanism 31, which is not visible in this illustration, extends, the edge band 49 is recessed. The edge band 44 is applied to the front end face 411 after integration of the fitting 34 into the composite element 40 or also after insertion of the fitting 30 into the composite element 40.

The edge band 44 is cut out so that it rests in sections on fitting 30 and covers, for example, the edges of the side plates 301 of fitting 30 or other elements visible outside the opening of fitting 30. In FIG. 3 the contours of fitting 30 are indicated by dashed lines. Due to the arrangement of the edge band 44 also on sections of the fitting 30, the fitting 30—except for the extendable lever mechanism 31—is completely integrated into the composite element 40 and no longer visible at the front end 411 of the composite element 40.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 Furniture body
11 Bottom panel
12 Top panel
13 Side wall
20 Flap
30 Fitting
31 Lever mechanism
40 Composite element
41 Core
411 Front end face
42 Outer cover layer
43 Inner cover layer
44 Edge band
50 Pivotable intermediate shelf
51 Shelf
52 Side part
53 Pivot bearing
60 Further fitting
61 Lever mechanism
62 Pivot bearing (furniture body side)

1-21. (canceled)

22. A wall of a furniture body, the wall comprising:
a fitting configured to guide a movable furniture part, wherein the fitting is integrated into the wall;
at least one further fitting configured to guide a structuring element is arranged on at least one side of the well;
at least one core arranged in a plane with the fitting,
two continuous cover layers between which the at least one core and the fitting are arranged,
wherein the at least one further fitting is a pivot fitting configured to guide the movable structuring element in a plane parallel to the cover layers,
wherein the at least one further fitting includes a lever mechanism with levers that are pivotably mounted on the wall in pivot bearings or is a guide fitting configured to linearly displace the movable structuring element, and
wherein the fitting comprises a lever mechanism configured to guide the movable furniture part and located between the two continuous cover layers in a closed state of the movable furniture part.

23. The wall of claim 22, wherein the two continuous cover layers are connected flatly to the at least one core and/or the fitting.

24. The wall of claim 23, wherein the two continuous cover layers are laminated flatly onto the at least one core and/or the fitting.

25. The wall of claim 22, wherein the at least one further fitting is fastened to one or both of the two continuous cover layers.

26. The wall of claim 22, wherein at least one further fitting is fastened with fastening means in bores in the two continuous cover layers.

27. The wall of claim 26, wherein at least one of the bores penetrates in an area provided on the fitting in order to accommodate a fastening means for the at least one further fitting.

28. The wall of claim 27, wherein sleeve-like recesses are present in the fitting for accommodating fastening means of the at least one further fitting, wherein the sleeve-like recesses are exposed by a bore through the two continuous cover layers.

29. The wall of claim 27, wherein the area in the fitting is formed from solid material.

30. The wall of claim 29, wherein the solid material in the fitting differs from a basic material of the fitting.

31. The wall of claim 30, wherein the basic material of the fitting is metal and the solid material is plastic or wood.

32. The wall of claim 27, wherein the lever mechanism is arranged in a front region of the fitting, and an energy accumulator for applying force is arranged in a rear region of the fitting, with at least one region for the bores for the fastening means for the further fitting being located between the lever mechanism and the energy accumulator in the fitting.

33. A piece of furniture or furniture body, comprising:
at least one wall, comprising
a fitting configured to guide a movable furniture part, wherein the fitting is integrated into the wall;
at least one further fitting configured to guide a structuring element is arranged on at least one side of the well;
at least one core arranged in a plane with the fitting,
two continuous cover layers between which the at least one core and the fitting are arranged,
wherein the at least one further fitting is a pivot fitting configured to guide the movable structuring element in a plane parallel to the cover layers,
wherein the at least one further fitting includes a lever mechanism with levers that are pivotably mounted on the wall in pivot bearings or is a guide fitting configured to linearly displace the movable structuring element, and
wherein the fitting comprises a lever mechanism configured to guide the movable furniture part and located between the two continuous cover layers in a closed state of the movable furniture part.

34. The piece of furniture or furniture body of claim 33, wherein the wall is a side wall, a partition wall, a bottom panel, a top panel, and/or an intermediate shelf.

35. The piece of furniture or furniture body of claim 33, wherein the wall has a door or flap fitting as the fitting.

36. The piece of furniture or furniture body of claim 33, further comprising:
at least one inserted structuring element for an interior space of the piece of furniture or furniture body, wherein the structuring element is configured to be guided over the at least one further fitting.
